(19) United States
(12) Patent Application Publication
(10) Pub. No.: US 2018/0223589 A1
(43) Pub. Date: Aug. 9, 2018

(54) INSULATING DOOR AND FRAME

(71) Applicant: Thermoseal Industries, LLC, Gloucester City, NJ (US)

(72) Inventors: Richard A. Chubb, Voorhees, NJ (US); Donald B. Cheke, Saskatoon (CA)

(21) Appl. No.: 15/886,286

(22) Filed: Feb. 1, 2018

Related U.S. Application Data
(60) Provisional application No. 62/456,811, filed on Feb. 9, 2017.

(51) Int. Cl. E06B 3/263; E05D 15/06

(52) U.S. Cl. CPC E06B 3/26347; E05Y 2900/132; E05D 15/0652

(57) ABSTRACT

Door, frame, and door and frame assembly embodiments are disclosed herein. The disclosed embodiments can provide one or more useful insulating features in a variety of applications. One embodiment of a door includes a glass unit and a rail assembly receiving the glass unit. The rail assembly can include a first body having a first sidewall and a first insulating member secured to the first sidewall. The first insulating member can have a first wall and a second wall spaced from the first wall by a first support and a second support. The first wall, the second wall, the first support, and the second support can define a first cavity of the first insulating member.

### RELATED APPLICATION

This application claims priority to U.S. Provisional Patent Application No. 62/456,811, filed Feb. 9, 2017, and the entire contents of which are hereby incorporated by reference.

### TECHNICAL FIELD

This disclosure relates generally to features for doors and/or door frames. More particularly, this disclosure provides one or more features for door and/or door frame insulation.

### BACKGROUND

Door assemblies are generally used to provide access to an enclosed space. A door and frame assembly can include one or more doors and a frame. Generally, the frame is secured at an opening to the enclosed space and one or more doors are fittingly supported to the frame. The door can then be moved (e.g., slid, pivoted, etc.) relative to the frame when the enclosed space is to be accessed.

In some cases, the enclosed space to which a door and frame assembly provides access may be a temperature controlled enclosure (e.g., a refrigerator, freezer, etc.). In this type of application, the door and frame assembly needs to insulate the temperature controlled enclosure from an ambient environment. If the door and frame assembly is unable to provide adequate insulation for the temperature controlled enclosure, costs associated with maintaining the enclosure can be significant. Moreover, in many cases, certain standards for energy usage may need to be met.

### SUMMARY

In general, the disclosed embodiments of doors, door frames, and door and frame assemblies provide useful insulation, for instance when any or all of the same are used to provide access to a temperature controlled enclosure (e.g., refrigerator, freezer, etc.). In such instances, the disclosed embodiments of doors, door frames, and door and frame assemblies can provide efficiencies in maintaining the enclosure. Yet, at the same time, the disclosed embodiments of doors, door frames, and door and frame assemblies may be easy to manufacture and assemble while not substantially increasing a required footprint of the door, door frame, and/or door and frame assembly. As such, the disclosed embodiments may be able to achieve such efficiencies in maintaining the enclosure without significantly increasing the cost associated with implementing the disclosed embodiments.

In one exemplary embodiment, a door includes a glass unit and a rail assembly. The rail assembly receives the glass unit. The rail assembly includes a first rail body having a first sidewall and a first insulating member secured to the first sidewall. The first insulating member has a first wall and a second wall spaced from the first wall by a first support and a second support. The first wall, the second wall, the first support, and the second support define a first cavity of the first insulating member.

In further embodiments, this door can include one or more additional features. In one further embodiment, the first insulating member of this door can define additional cavities. Here, the first insulating member further includes a third support. The second wall is spaced from the first wall by the first support, the second support, and the third support. The first wall, the second wall, the second support, and the third support define a second cavity of the first insulating member. In another further door embodiment, the first wall of the first insulating member includes two legs extending out from a surface of the first wall and spaced along the surface from each other. The first sidewall defines one or more gaps that receive the two legs of the first wall. In an additional door embodiment, a secondary insulating component can be included and located between a second rail body of the rail assembly and the first insulating member such that the secondary insulating component is at a location interfacing with the received glass unit.

In another exemplary embodiment, a frame includes a mullion and a frame header and/or sill assembly extending perpendicular to the mullion. The frame header and/or sill assembly includes a first body having a first sidewall and a second body having a second sidewall. The second sidewall is spaced from the first sidewall by a first support and a second support. The first sidewall, the second sidewall, the first support, and the second support define a first cavity between the first body and the second body. In a further embodiment, the mullion includes a third body and a fourth body positioned within an interior area defined by the third body. The fourth body has a third sidewall, a fourth sidewall, and a fifth sidewall. A transition from the third sidewall to the fourth sidewall forms a convex portion at the surface of the fourth body facing the third body. A transition from the fifth sidewall to the fourth sidewall forms a convex portion at the surface of the fourth body facing the third body.

A further exemplary embodiment includes a door and frame assembly. The door and frame assembly has a door and a frame. The door has a glass unit and a door rail assembly receiving the glass unit. The door rail assembly includes a first rail body having a first sidewall and a first insulating member secured to the first sidewall. The first insulating member has a first wall and a second wall spaced from the first wall by a first support and a second support. The first wall, the second wall, the first support, and the second support define a first cavity of the first insulating member. The frame has a mullion and a frame header and/or sill assembly extending perpendicular to the mullion. The frame header and/or sill assembly includes a second body having a second sidewall and a third body having a third sidewall. The third sidewall is spaced from the second sidewall by a third support and a fourth support. The second sidewall, the third sidewall, the third support, and the fourth support define a second cavity between the second body and the third body.

The details of one or more examples are set forth in the accompanying drawings and the description below. Other features, objects, and advantages will be apparent from the description and drawings, and from the claims.

### BRIEF DESCRIPTION OF DRAWINGS

The following drawings are illustrative of particular embodiments of the present invention and therefore do not limit the scope of the invention. The drawings are not necessarily to scale (unless so stated) and are intended for use in conjunction with the explanations in the following detailed description. Embodiments of the invention will hereinafter be described in conjunction with the appended drawings, wherein like numerals denote like elements.

FIG. 1 is a perspective view of an exemplary embodiment of a door and fame assembly.

FIG. 2 is a perspective view of an exemplary embodiment of a door that can, for instance, be used in the door and frame assembly of FIG. 1.

FIG. 3A is a cross-sectional view of an exemplary embodiment of a rail assembly of the door in FIG. 2. In various embodiments, a cross-section of a stile assembly of the door in FIG. 2 can be the same as, or similar to, the illustrated embodiment of the rail assembly in FIG. 3A.

FIG. 3B is a cross-sectional view of another exemplary embodiment of a rail assembly of the door in FIG. 2. In various embodiments, a cross-section of a stile assembly of the door can be the same as, or similar to, the illustrated embodiment of the rail assembly in FIG. 3B.

FIG. 4 is a perspective view of an exemplary embodiment of a frame that can, for instance, be used in the door and frame assembly of FIG. 1.

FIG. 5 is a cross-sectional view of an exemplary embodiment of a header or still (e.g., common frame) assembly of the frame in FIG. 4. In various embodiments, a cross-section of a jamb assembly of the frame in FIG. 4 can be the same as, or similar to, the illustrated embodiment of the header or sill assembly in FIG. 5.

FIG. 6 is a cross-sectional view of an exemplary embodiment of a mullion assembly of the frame in FIG. 4.

### DETAILED DESCRIPTION

The following detailed description is exemplary in nature and is not intended to limit the scope, applicability, or configuration of the invention in any way. Rather, the following description provides some practical illustrations for implementing exemplary embodiments of the present invention. Examples of constructions, materials, and/or dimensions are provided for selected elements. Those skilled in the art will recognize that many of the noted examples have a variety of suitable alternatives.

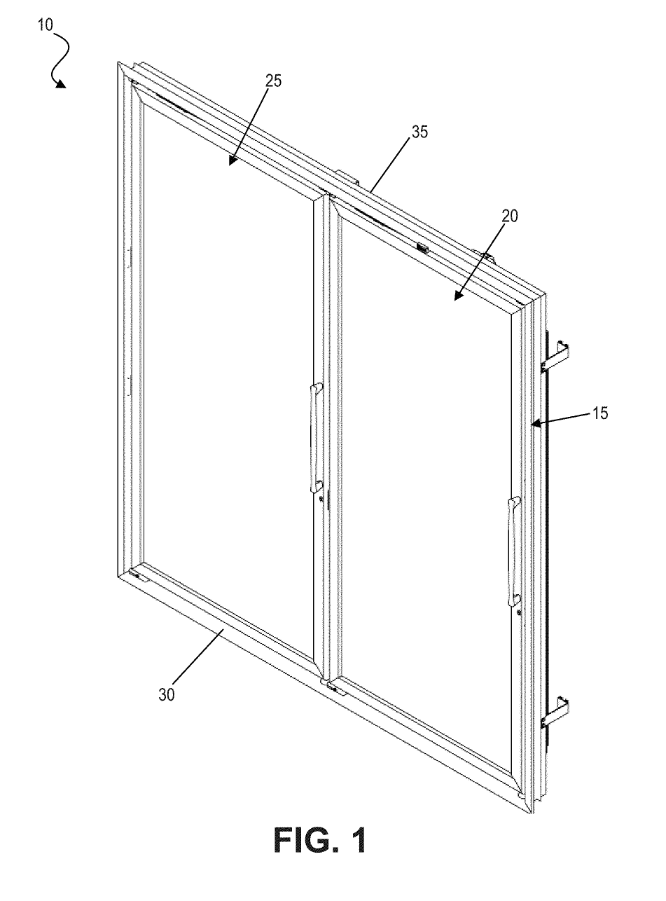

FIG. 1 shows a perspective view of an exemplary embodiment of a door and frame assembly 10. In some applications, the door and frame assembly 10 can be mounted to an open portion of an enclosure (not shown). In this way, the door and frame assembly 10 may serve to provide access to the enclosure. In one application, the enclosure can be a temperature controlled enclosure (e.g., refrigerator, freezer, etc.) where a temperature on one side of the door and frame assembly 10 is controlled to differ from (e.g., be lower than) a temperature on an opposite side of the door and frame assembly 10. For example, a front side 30 of the door and frame assembly 10 may interface with an ambient environment while a rear side 35 of the door and frame assembly 10 interfaces with the temperature controlled enclosure. The disclosed embodiments of the door and frame assembly 10 can provide useful insulation between the temperature controlled enclosure at the rear side 35 and the ambient environment at the front side 30.

The illustrated embodiment of the door and frame assembly 10 includes a frame 15, a first door 20, and a second door 25. Although the present description uses the example of a two doors and single frame assembly 10, other door assembly embodiments can include various numbers of doors per frame, such as a single door 20 or 25. Both the frame 15 and doors 20, 25 may be dimensioned such that the frame 15 fittingly supports both doors 20, 25 within the frame 15. The one or more doors 20, 25 can be any one of a variety of different types of doors, such as swing doors, slide doors, or other appropriate doors. For instance, in the door and frame assembly 10 shown here the doors 20, 25 can be referred to as swing doors and are pivotally coupled to the frame 15. In another embodiment, the doors 20, 25 can be slide doors that are slidingly coupled to the frame 15.

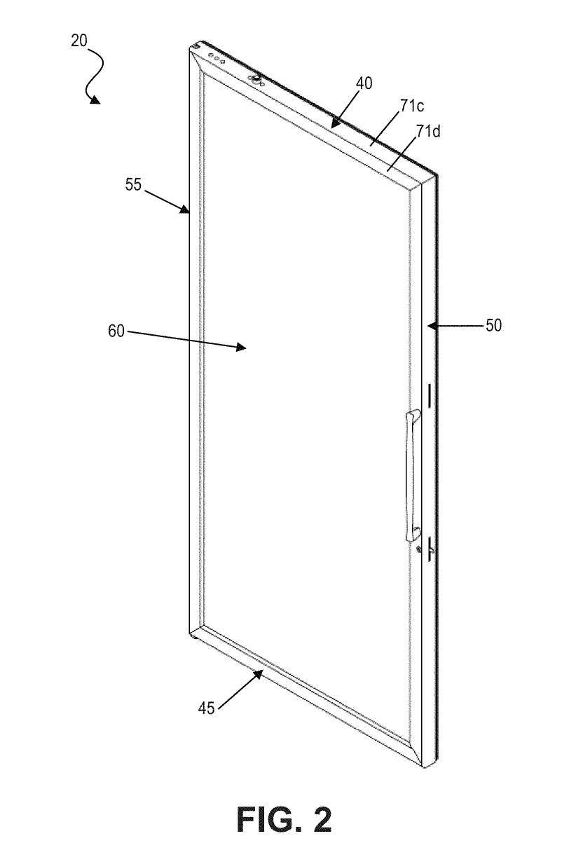

FIG. 2 shows a perspective view of an exemplary embodiment of the door 20 in FIG. 1. The illustrated door 20 includes a first rail assembly 40, a second rail assembly 45, a first stile assembly 50, and a second stile assembly 55. The term “stile” can be used to refer to a vertical support member of the door, while the term “rail” can be used to refer to a horizontal support member of the door. Though, in some instances for convenience, the term “rail” can be used as a general term for both vertical and horizontal support members of the door (e.g., rail assemblies 40, 45, 50, and 55). In the illustrated embodiment, each of the assemblies 40, 45, 50, and 55 receives a glass unit 60 and together they bound and support the glass unit 60, for instance around a perimeter of the glass unit 60. Depending on the intended application of the door 20, the glass unit 60 can be an insulating glass unit 60, for instance having multiple spaced apart glass panes. As will be explained in more detail herein, one or more (e.g., all) of the assemblies 40, 45, 50, and 55 can include one or more features for providing insulation between an enclosure, to which the door 20 allows access, and an ambient environment to which the door 20 interfaces. As one example, disclosed embodiments can provide insulation at the interface between the glass unit 60 and one or more of the assemblies 40, 45, 50, and 55, and thereby provide insulation between the enclosure and the ambient environment. As another example, disclosed embodiments can provide insulation at the frame in the door and frame assembly in addition to, or as an alternative to, insulation at the interface between the glass unit 60 and one or more of the assemblies 40, 45, 50, and 55.

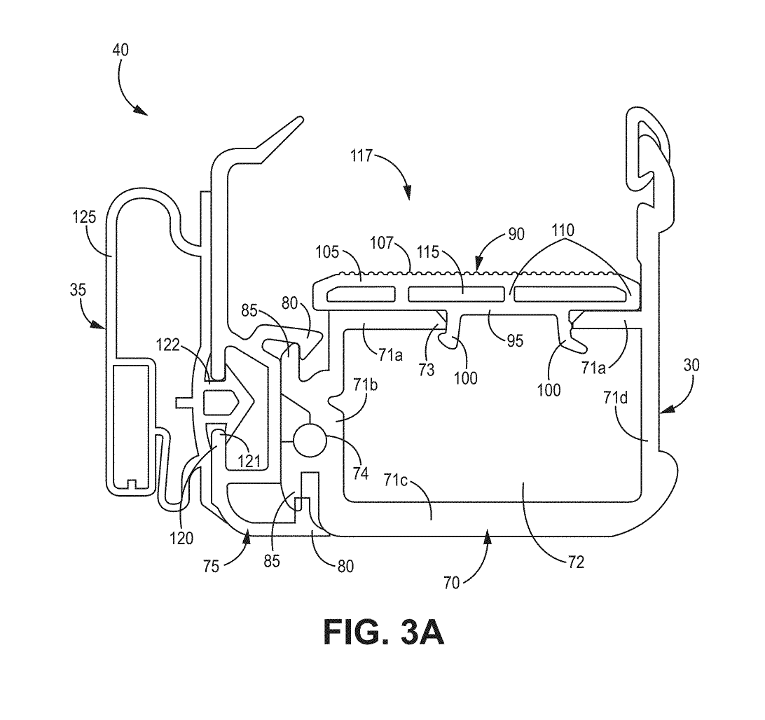

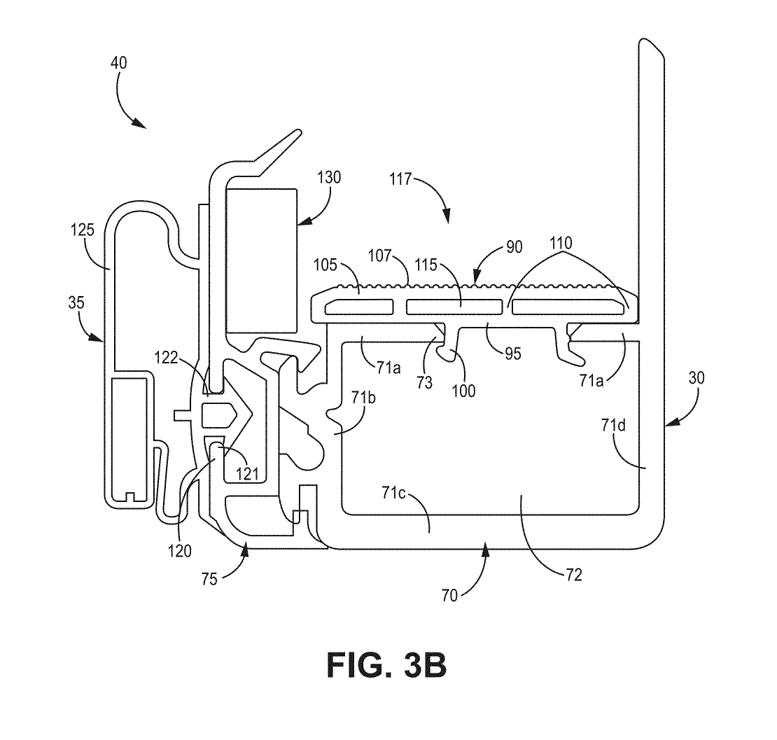

FIG. 3A shows a cross-sectional view of an exemplary embodiment of the rail assembly 40 (of the door 20 shown in FIG. 2). The cross-section shown here is taken perpendicular to a longitudinal axis of the rails assembly 40. In various embodiments, a cross-section of the rail assembly 45, stile assembly 50, and/or stile assembly 55 of the door 20 can be the same as, or similar to, the illustrated embodiment of the rail assembly 40 in FIG. 3A. Namely, in one embodiment of the door 20, each of the rail assembly 40, rail assembly 45, stile assembly 50, and stile assembly 55 of the door 20 can have the cross-section, at least at a portion thereof, as shown and described in connection with FIG. 3A. Accordingly, in such embodiment, each of the features shown and/or described with respect to the rail assembly 40 in FIG. 3A could be present in the rail assembly 45, stile assembly 50, and stile assembly 55 of the door 20.

The illustrated rail assembly 40 includes a first rail body 70 and a second rail body 75. In examples where a stile assembly has the same cross-section as the rail assembly 40, these can be referred to as a first stile body and a second stile body, respectively. In some embodiments, the rail bodies 70, 75 are made of differing materials (e.g., having different thermal conductivities, such as the first rail body 70 having a greater thermal conductivity than the second rail body 75). For instance, in one embodiment the first rail body 70 can be made of metallic material (e.g., aluminum and/or alloys thereof) while the second rail body 75 can be made of a polymer material (e.g., PVC). In the example shown, the second rail body 75 is attached to the first rail body 70. More particularly, opposing attachment members 80 of the second rail body 75 are fit with corresponding opposing receiving members 85 of the first rail body 70. As shown, each receiving member 85 forms a receiving slot within which the respective attachment member 80 can be received. This can allow the second rail body 75 to be snap fit onto the first rail body 70, and thereby secured in place at the first rail body 70 via an interference fit between the corresponding attachment members 80 and the receiving members 85. In other cases, the first rail body 70 and the second rail body 75 can be an integral rail body component.

The first rail body 70 in the embodiment illustrated in FIG. 3A includes four sidewalls 71a, 71b, 71c, and 71d. The four sidewalls generally define a first cavity 72. In the illustrated embodiment, sidewall 71a defines a gap 73 along its length, and thus can be a discontinuous surface. Sidewall 71b includes the receiving members 85 on a side opposite the first cavity 72. Sidewall 71b also includes, on the side opposite the first cavity 72, a wire retention structure 74 that can be configured to receive and hold a wire component (e.g., a heater wire) in place thereat. Sidewall 71d can form all, or a portion of, the front side 30 of the rail assembly 40.

The embodiment of the rail assembly 40, as shown, further includes an insulating member 90. The exemplary insulating member 90 shown in FIG. 3A includes a first wall 95 with legs 100 extending out from a surface of the first wall 95. The insulting member 90 further includes a second wall 105 spaced from, and here extending generally parallel to, the first wall 95. As shown, the second wall 105 includes a ribbed surface 107 on a side of the second wall 105 opposite the first wall 95. The second wall 105 is spaced from, and connected to, the first wall 95 by a number of supports 110. Each of the supports 110 is connected to the first wall 95 at a first end and extends to and is connected to the second wall 105 at a second opposite end. In the illustrated example, the insulating member 90 includes four supports 110, but in other embodiments there can be various numbers of supports 110 (e.g., two, three, five, six, etc.). The supports 110, first wall 95, and second wall 105 define a number of cavities 115. The cavities 115, as shown here, are generally aligned with one another and spaced from one another along a length of the insulating member 90 that is generally parallel to the sidewall 71a. In the illustrated example, the insulating member 90 includes three cavities 115, but in other embodiments there can be various numbers of cavities 115 (e.g., one, two, four, five, etc.). The number of cavities 115 included at the insulating member 90 can be a function of the number of supports 110 included at the insulating member 90, for instance such that the insulating member 90 can have n number of supports 110 and n−1 number of cavities 115.

The insulating member 90 can be secured to the first rail body 70, such as shown in FIG. 3A. In this example, the insulating member 90 is secured to the sidewall 71a at the gap 73. In particular, the first wall 95 contacts the sidewall 71a and extends across the gap 73 while the legs 100 extend into the gap 73. In this way, the legs 100 can secure the insulating member 90 to the sidewall 71a in a first direction while the first wall 95 can secure the insulating member 90 to the sidewall 71a in a second opposite direction. When the insulating member 90 is secured to the first rail body 70 as shown here, the second wall 105 is spaced from the sidewall 71a by the first wall 95 as well as the supports 110 and cavities 115. In other examples, the insulating member 90 can extend a distance into contact with the second rail body 75 and, in such examples, may additionally be secured to the second rail body 75 thereat.

When the rail assembly 40 is used as part of the door 20, the glass unit 60 may be received and held at the rail assembly 40 generally at a location 117 between the first rail body 70 and the second rail body 75. The glass unit 60 can be received as the rail assembly 40 so as to interface with the insulating member 90. The insulating member 90 can provide insulation between the glass unit 60 and the rail assembly 40. For example, the presence of the first wall 95 and the second wall 105, and the cavities 115 therebetween, may provide a door with enhanced insulating functionality since it may provide an increased thermal break. As a result, costs associated with maintaining an enclosure may be reduced. In certain embodiments, the ribbed surface 107 of the second wall 105 can interface with the glass unit 60. In one instance of the ribbed surface 107 interfacing with the glass unit 60 the ribbed surface 107 may contact the glass unit 60, while in another instance of the ribbed surface 107 interfacing with the glass unit 60 an intermediate material (e.g., a sealant) may be between the ribbed surface 107 and the glass unit 60.

The second rail body 75 can include a rear attachment structure 120 for receiving a rear seal 125. The rear seal 125 can be received and secured at the second rail body 75 via the rear attachment structure 120. In such an embodiment, the rear side 35 of the rail assembly 40 can be formed, at least in part, by the rear seal 125. The second rail body 75 can include a gap 121 at which a securing element 122 of the rear seal 125 is received. As shown here, the securing element 122 includes two parallel sides each extending to a pointed end (e.g., a “V” shaped end) and this pointed end can be received at the gap 121 of the second rail body 75 so as to secure the rear seal 125 thereat.

In one application, the door 20 can be secured to the frame 15 such that the rear side 35 of the rail assembly 40 faces a temperature controlled enclosure, while the front side 30 of the rail assembly 40 faces an ambient environment. In this application, both the rear seal 125 and the insulating member 90 can act to increase the effectiveness of the door 20 to insulate the enclosure from the ambient environment.

As noted previously, the door 20 can, in some embodiments, include the rail assembly 45, stile assembly 50, and/or stile assembly 55 with cross-sections that are the same as, or similar to, that cross-section illustrated and described here with respect to the rail assembly 40 in FIG. 3A. For instance, one embodiment of a door can include rail/stile assembly 40, 45, 50, and 55 of the cross-section (including the insulating member 90) illustrated and described in connection with FIG. 3A. The same may be true for a second door (e.g., the door 25) of a door and frame assembly.

FIG. 3B shows a cross-sectional view of another exemplary embodiment of the rail assembly 40 (of the door 20 shown in FIG. 2). In various embodiments, a cross-section of the rail assembly 45, stile assembly 50, and/or stile assembly 55 of the door 20 can be the same as, or similar to, the illustrated embodiment of the rail assembly 40 in FIG. 3B.

The embodiment of the rail assembly 40 illustrated in FIG. 3B includes the same features illustrated and described in connection with the embodiment of the rail assembly 40 illustrated in FIG. 3A, unless otherwise shown or described. One difference in the embodiment of FIG. 3B is the design at the front side 30. In the embodiment shown in FIG. 3B, the front side 30 defines a substantially more flat rail design on a side of the sidewall 71d opposite the cavity 72. This substantially more flat design extends along the front side 30 past the sidewall 71a to the location 117 where the glass unit 60 is held. Thus, the rail assembly 40 can be included across a variety of door design iterations while maintaining substantially the same component features and useful benefits. This can allow a variety of door designs to be implemented as desired for a specific application while still providing one or more improved insulating features.

One other difference shown in the embodiment of FIG. 3B is the inclusion of secondary insulating component 130. Although shown only in the example of FIG. 3B, the secondary insulating component 130 can be used with the exemplary embodiment shown in FIG. 3A, for instance at the same position as shown in FIG. 3B, in some cases. As illustrated in the present example, the secondary insulating component 130 can be located between the second rail body 75 and the insulating member 90. The secondary insulating component 130 can thus be adjacent the location 117 where the glass unit 60 is received and held at the rail assembly 40. In this way, the secondary insulating component 130 can help to isolate the components of the door 20 from regions of differing temperatures. In some examples, the secondary insulating component 130 can be made of a different material (e.g., having a different thermal conductivity) than the second rail body 75 and/or the rear seal 125. In one such example, the secondary insulating component 130 can be made of a foam material (e.g., closed cell).

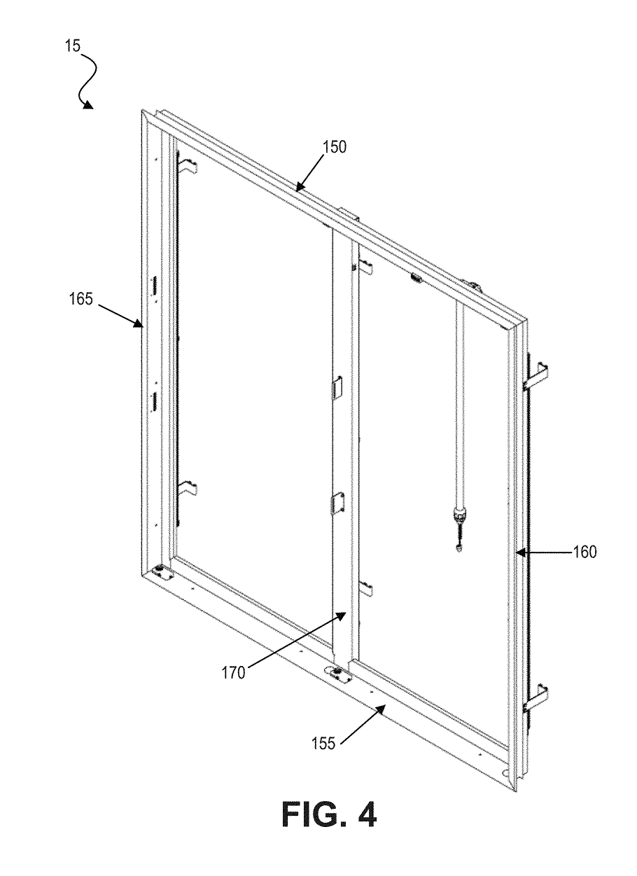

In addition to, or as an alternative to, providing one or more doors with one or more insulating features, a frame can include one or more insulating features. FIG. 4 shows a perspective view of an exemplary embodiment of the frame 15 (of the door and frame assembly 10 shown in FIG. 1). The illustrated frame 15 includes a header assembly 150, a sill assembly 155, a first jamb assembly 160, a second jamb assembly 165, and a mullion assembly 170. The term “jamb” can be used to refer to a vertical support member of the frame, while the term “header” or “sill” can be used to refer to a horizontal support member of the frame. Though, in some instances for convenience, the term “common frame profile” or “jamb” can be used as a general term for both vertical and horizontal support members of the door (e.g., common frame profile 150, 155, 160, and 165). The assemblies 150, 155, 160, 165, and 170 receive and support one or more doors (e.g., the doors 20, 25 as shown in the example of FIG. 1).

As will be explained in more detail, one or more (e.g., all) of the common frame profile assemblies 150, 155, 160, and 165 and the mullion assembly 170 can include one or more features for providing insulation between an enclosure, to which the frame 15 is secured, and an ambient environment. As one example, disclosed embodiments can provide insulation at the interface between the supported door and the frame 15, and thereby provide insulation between the enclosure and the ambient environment. As another example, disclosed embodiments can provide insulation at the frame 15 in addition to, or as an alternative to, insulation at the interface between the glass unit 60 and one or more of the rail assemblies 40, 45, 50, and 55.

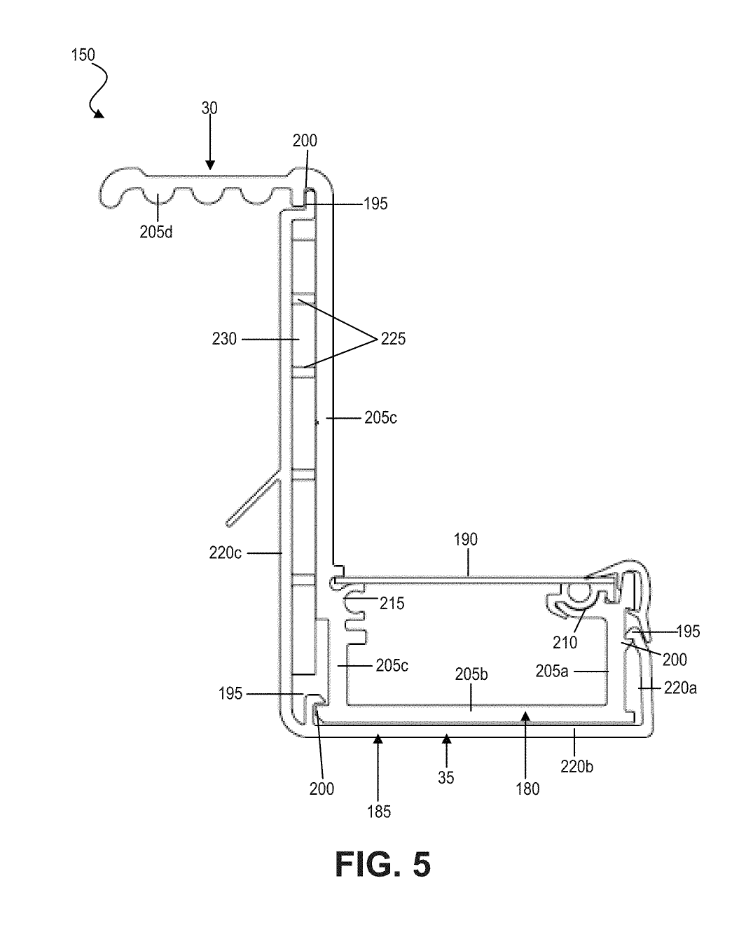

FIG. 5 shows a cross-sectional view of an exemplary embodiment of the common frame profile header assembly 150 (of the frame 15 shown in FIG. 4). In various embodiments, a cross-section of the sill assembly 155, right jamb assembly 160, and/or left jamb assembly 165 of the frame 15 can be the same or similar as the illustrated embodiment of the header assembly 150 in FIG. 5. Namely, in one embodiment of the frame 15, each of the header assembly 150, sill assembly 155, right jamb assembly 160, and left jamb assembly 165 of the frame 15 can have the common frame profile cross-section shown and described in connection with FIG. 5.

The illustrated header assembly 150 includes a first body 180, a second body 185, and a contact plate 190. In some embodiments, the bodies 180, 185 are made of differing materials (e.g., of differing thermal conductivity). For instance, in one embodiment the first body 180 can be made of metallic material (e.g., aluminum and/or alloys thereof) while the second body 185 can be made of a polymer material (e.g., PVC). In the example shown, the second body 185 is attached to the first body 180. More particularly, attachment members 195 of the second body 185 are fit with corresponding receiving members 200 of the first body 180. As shown, each receiving member 200 forms a receiving surface or slot for the respective attachment member 195. This can allow the second body 185 to be snap fit onto the first body 180, and thereby secured in place at the first body 180 via an interference fit between the corresponding attachment members 195 and the receiving member 200. In other cases the first body 180 and the second body 185 can be an integral body component. As shown, the contact plate 190 is connected to the first body 180. The contact plate 190 can directly contact a door when the door is in a closed position at the frame 15.

The first body 180 in the embodiment illustrated in FIG. 5 includes four sidewalls 205a, 205b, 205c, and 205d. The sidewall 205a receives one end of the contact plate 190 and defines a wire retention structure 210 that can be configured to receive and hold a wire component (e.g., a heater wire) in place thereat. The wire retention structure 210 is of a geometry to focus the received wire structure onto the contact plate 190. This can be useful in efficiently concentrating energy from the wire (e.g., heater wire) onto the contact plate 190. The sidewall 205b can form the rear side 35 of the first body 180. The sidewall 205c defines a wire retention structure 215 that can be configured to receive and hold a wire component (e.g., a heater wire) in place thereat. The sidewall 205c, in the embodiment shown, can receive another end of the contact plate 190 and extend past a location at which the contact plate 190 is received. The sidewall 205d can form the front side 30 of the first body 180.

The second body 185, in the embodiment illustrated in FIG. 5, includes three sidewalls 220a, 220b, and 220c. The sidewall 220b can form the rear side 35 of the second body 185, and in the embodiment shown here the rear side 35 of the header assembly 150. The sidewall 220c can extend generally parallel to the sidewall 205 of the first body 180.

The sidewall 220c of the second body 185 is spaced from the sidewall 205c of the first body 180 by a number of supports 225. In the example shown, each of the supports 225 is formed on the second body 185 and is connected to the sidewall 220c at a first end and extends to and contacts the sidewall 205c at a second opposite end. In other embodiments, the supports 225 can be formed on the first body 180 and connected to the sidewall 205c, in addition to or as an alternative to being formed on the sidewall 220c. In the illustrated example, the rail assembly 150 includes five supports 225, but in other embodiments there can be various numbers of supports 225 (e.g., two, three, four, six, etc.). The supports 225, sidewall 220c, and sidewall 205c define a number of cavities 230. The cavities 230, as shown here, are generally spaced from one another along an extent of the sidewalls 205c, 220c that is generally perpendicular to respective planes defined by the front and rear sides 30, 35. In the example here, the rail assembly 150 includes five cavities 230, but in other embodiments there can be various numbers of cavities 230 (e.g., one, two, three, four, six, etc.). In certain embodiments, a filler material can be located in one or more (e.g., all) of the cavities 230 and thus such filler material may extend along the extent of the sidewalls 205c, 220c between the corresponding supports 225.

When the header assembly 150 is used as part of the frame 15, the header assembly 150 can act to provide insulation between the enclosed space, to which the frame 15 is secured, and the ambient environment. For instance, the cavities 230 created by the supports 225 can result in an increased thermal break along the extent of the header assembly 150 between the front side 30 (e.g., ambient environment side) and the rear side 35 (e.g., enclosed space side). This can hold true as well where the cavities 230 contain filler material (e.g., foam tape, such as closed cell foam tape). As a result, costs associated with maintaining an enclosure may be reduced. Furthermore, the supports 225 can provide enhanced structural support to the assembly 150, and where includes across multiple of the assemblies 150, 155, 160, and 165 enhanced structural support to the frame 15.

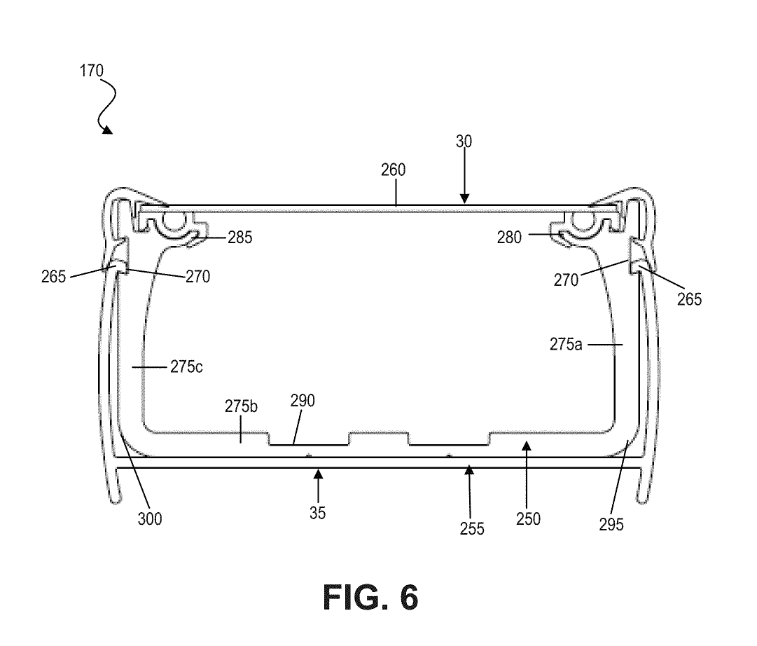

FIG. 6 shows a cross-sectional view of an exemplary embodiment of the mullion assembly 170 (of the frame 15 shown in FIG. 4). The mullion assembly 170 can be used to provide insulation to the frame 15 in addition to, or as an alternative to, the rail/stile assemblies 150, 155, 160, and 165.

The illustrated embodiment of the mullion assembly 170 includes a first body 250, a second body 255, and a contact plate 260. As shown, the first body 250 is generally received within an interior area defined by the second body 255. In some embodiments, the bodies 250, 255 are made of differing materials. For instance, in one embodiment the first body 250 can be made of metallic material (e.g., aluminum and/or alloys thereof) while the second body 255 can be made of a polymer material (e.g., PVC). In the example shown, the second body 255 is attached to the first body 250. More particularly, attachment members 265 of the second body 255 are fit with corresponding receiving members 270 of the first body 250. As shown, each receiving member 270 forms a receiving surface or slot for the respective attachment member 265. This can allow the second body 255 to be snap fit onto the first body 250, and thereby secured in place at the first body 250 via an interference fit between the corresponding attachment member 265 and the receiving member 270. In other cases the first body 250 and the second body 255 can be an integral body component. As shown, the contact plate 260 is received at the first body 250. The contact plate 260 can directly contact a door when the door is in a closed position at the front side 30 of the frame 15.

The first body 250 in the embodiment illustrated in FIG. 6 includes sidewalls 275a, 275b, and 275c. The sidewalls 275a and 275c each receive one end of the contact plate 260 and define, respectively, a wire retention structure 280 and 285 that can be configured to receive and hold a wire component (e.g., a heater wire) in place thereat. As shown, the wire retention structures 280, 285 are configured to concentrate the wire onto the contact plate 260. The sidewall 275b extends generally perpendicular to the contact plate 260 and includes one or more notches 290 defined along an extent thereof.

As seen in the illustrated embodiment, a transition from the sidewall 275a to the sidewall 275b forms a convex portion 295 at a surface of the first body 250 facing the second body 255. Similarly, a transition from the sidewall 275c to the sidewall 275b forms a convex portion 300 at a surface of the first body 250 facing the second body 255. The convex portions 295, 300 can generally conform to the surrounding geometry of the second body 255, and thereby serve to occupy a significant portion of the space between the first body 250 and the second body 255 at the transitions between the sidewalls 275a, 275c and the sidewall 275b. These convex portions 295, 300 may allow the mullion assembly 170 to provide insulation at the frame 15.

Embodiments of doors, frames, and door assemblies have been disclosed herein. One or more of these embodiments can be used with any one or more other disclosed embodiments, for instance, to provide a structure with useful insulating and/or structural features in a variety of applications.

Although the present invention has been described with reference to certain disclosed embodiments, the disclosed embodiments are presented for purposes of illustration and not limitation and other embodiments of the invention are possible. A variety of related methods (e.g., methods of manufacturing, methods of installing, methods of using) are also within the scope of the present invention. One skilled in the art will appreciate that various changes, adaptations, and modifications may be made without departing from the spirit of the invention.

What is claimed is:

1. A door comprising:
a glass unit; and
a rail assembly receiving the glass unit, the rail assembly comprising:
a first rail body having a first sidewall, and
a first insulating member secured to the first sidewall of the first rail body, the first insulating member having a first wall and a second wall, the second wall spaced from the first wall by a first support and a second support, wherein the first wall, the second wall, the first support, and the second support define a first cavity of the first insulating member.

2. The door of claim 1, wherein the first insulating member further comprises a third support, the second wall being spaced from the first wall by the first support, the second support, and the third support, and wherein the first wall, the second wall, the second support, and the third support define a second cavity of the first insulating member.

3. The door of claim 2, wherein the first cavity and the second cavity are aligned with one another and spaced apart along a length of the first insulating member.

4. The door of claim 1, wherein the first wall includes a first leg and a second leg each extending out from a surface of the first wall.

5. The door of claim 4, wherein the first sidewall defines a gap that receives the first leg and the second leg.

6. The door of claim 1, wherein the second wall includes a ribbed surface on a side of the second wall opposite the first wall.

7. The door of claim 1, wherein the first rail body further includes a second sidewall, a third sidewall, and a fourth sidewall, and wherein the first sidewall, the second sidewall, the third sidewall, and the fourth sidewall collectively form a cavity.

8. The door of claim 7, wherein the second sidewall extends from the first sidewall, wherein the second sidewall includes receiving members on a side opposite the cavity.

9. The door of claim 8, wherein the second sidewall includes a wire retention structure that is configured to hold a wire component in place at the rail assembly.

10. The door of claim 1, wherein the rail assembly further comprises a second rail body attached to the first rail body.

11. The door of claim 10, wherein the second rail body includes attachment members, and wherein the attachment members of the second rail body are received at corresponding receiving slots of opposing receiving members of the first rail body.

12. The door of claim 10, wherein the glass unit is received at the rail assembly at a location between the first rail body and the second rail body.

13. The door of claim 12, wherein the glass unit interfaces with the second wall of the first insulating member.

14. The door of claim 10, wherein the second rail body further comprises a rear seal, the rear seal including a securing element that is received at a gap of the second rail body to secure the rear seal to the second rail body.

15. The door of claim 10, wherein the first rail body and the second rail body are made of different materials, with the first rail body having a greater thermal conductivity than the second rail body.

16. The door of claim 1, further comprising:
a stile assembly extending generally perpendicular to the rail assembly and receiving the glass unit, the stile assembly comprising:
a first stile body having a first sidewall, and
a second insulating member secured to the first sidewall of the first stile body, the second insulating member having a third wall and a fourth wall spaced from the third wall by a fourth support and a fifth support, wherein the third wall, the fourth wall, the fourth support, and the fifth support define a third cavity of the second insulating member.

17. A frame comprising:
a mullion; and
a header or sill assembly extending perpendicular to the mullion, the header or sill assembly comprising:
a first body having a first sidewall, and
a second body having a second sidewall, the second sidewall spaced from the first sidewall by a first support and a second support, wherein the first sidewall, the second sidewall, the first support, and the second support define a first cavity between the first body and the second body.

18. The frame of claim 16, wherein the mullion comprises:
a third body; and
a fourth body positioned within an interior area defined by the third body, the fourth body having a third sidewall, a fourth sidewall, and a fifth sidewall, wherein a transition from the third sidewall to the fourth sidewall forms a convex portion at the surface of the fourth body facing the third body, and wherein a transition from the fifth sidewall to the fourth sidewall forms a convex portion at the surface of the fourth body facing the third body.

19. A door and frame assembly comprising:
a door comprising:
a glass unit, and
a door rail assembly receiving the glass unit, the door rail assembly comprising:
a first rail body having a first sidewall, and
a first insulating member secured to the first sidewall, the first insulating member having a first wall and a second wall spaced from the first wall by a first support and a second support, wherein the first wall, the second wall, the first support, and the second support define a first cavity of the first insulating member; and
a frame comprising:
a mullion, and
a frame header or sill assembly extending perpendicular to the mullion, the frame header or sill assembly comprising:
a second body having a second sidewall, and
a third body having a third sidewall, the third sidewall spaced from the second sidewall by a third support and a fourth support, wherein the second sidewall, the third sidewall, the third support, and the fourth support define a second cavity between the second body and the third body.

20. The door and frame assembly of claim 19, wherein the first insulating member further comprises a fifth support, the second wall being spaced from the first wall by the first support, the second support, and the fifth support, wherein the first wall, the second wall, the second support, and the fifth support define a third cavity of the first insulating member, and wherein the first cavity and the third cavity are aligned with one another and spaced apart along a length of the first insulating member.
